(19) United States
(12) Patent Application Publication
(10) Pub. No.: US 2010/0259056 A1
(43) Pub. Date: Oct. 14, 2010

(54) Post Hole Digger

(75) Inventors: Brooks M. Freeman, Dallas, TX (US); Andrei Kersha, Framingham, MA (US); Robert Ciskowski, Concord, MA (US)

Correspondence Address: BAKER & DANIELS LLP, 300 NORTH MERIDIAN STREET, SUITE 2700, INDIANAPOLIS, IN, 46204, US

(73) Assignee: PROTOWRIGHT LLC, Dallas, TX (US)

(21) Appl. No.: 12/444,123

(22) PCT Filed: Oct. 2, 2007
(86) PCT No.: PCT/US07/21161

§ 371 Date: Apr. 2, 2009

Related U.S. Application Data
(60) Provisional application No. 60/848,774, filed on Oct. 2, 2006.
(60) Provisional application No. 60/899,743, filed on Feb. 6, 2007.

(51) Int. Cl. A01B 1/16

(52) U.S. Cl. 294/50.8

(57) ABSTRACT

A post hole digger is disclosed that is adapted to loosen earth and facilitate remove of the loosened earth from the post hole. The post hole digger may includes a pair of handles pivotably coupled together and a pair of spherical blades pivotably coupled to the pair of handles and to each other.

### RELATED APPLICATIONS

The present application claims the benefit of U.S. Provisional Patent Application Ser. No. 60/848,774, filed Oct. 2, 2006, to Freeman et al., titled “Post Hole Digger,” and U.S. Provisional Patent Application Ser. No. 60/899,743, filed Feb. 6, 2007, to Freeman et al., titled “Post Hole Digger,” the disclosures of which are expressly incorporated by reference herein.

### BACKGROUND AND SUMMARY OF THE INVENTION

The present invention relates generally to post hole diggers. More particularly the present invention relates to post hole diggers that facilitate removal of loose earth from a hole.

### BRIEF DESCRIPTION OF THE DRAWINGS

The detailed description of the drawing particularly refers to the accompanying figures in which:

FIG. 1 is a perspective view of a post hole digger showing the post hole digger in a partially open position;

FIG. 2 is a view similar to FIG. 1 showing the post hole digger in a slightly more open position;

FIG. 3 is an enlarged perspective view showing the post hole digger including a pair of handles and a pair of spherical blades pivotably coupled to the handles and to each other;

FIG. 4. is a perspective view of the spherical blades shown in an open position;

FIG. 5 is a perspective view of the spherical blades in a closed position;

FIG. 6 is a perspective view of the spherical blades in a partially open position;

FIG. 7 is a perspective view of one of the spherical blades;

FIG. 8 is a side elevation view of one of a pair of hinge members of the handles that couples to the spherical blades to the handles;

FIG. 9 is a perspective view of an alternative embodiment post hole digger showing the spherical blades in a substantially open position and including a pair of reinforcement strips coupled to an inside of the spherical blades and to a pair of collars coupled to the reinforcement strips;

FIG. 10 is a side elevation view of the post hole digger of FIG. 9 showing the blades in the open position;

FIG. 11 is a view similar to FIG. 10 showing the blades tilted relative to the handles;

FIG. 12 is a perspective view of the post hole digger of FIG. 10 showing the handles coupled to the blades;

FIG. 13 is a perspective view of another alternative embodiment post hole digger including an external shell coupled to the spherical blades;

FIG. 14 is a perspective view of the external shell of FIG. 13;

FIG. 15 is another perspective view of the external shell of FIG. 13;

FIG. 16 is an enlarged perspective view of a top portion of the external shell of FIG. 13 showing the shell including a transverse member having a pair of handle-receiving sockets;

FIG. 17 is an enlarged perspective view of the post hole digger of FIG. 13 showing the spherical blades in a partially open position and lower portions of the handles coupled to portions of the spherical blades and positioned to be received within the handle-receiving sockets of the external shell;

FIG. 18 is a view similar to FIG. 17 showing the spherical blades in a closed position and the lower portions of the handles positioned in the handle-receiving sockets; and

FIG. 19 is a side elevation view of a hinge member for the lower ends of the handles of the post hole digger of FIG. 13.

### DETAILED DESCRIPTION OF THE ILLUSTRATED EMBODIMENTS

The embodiments disclosed below are not intended to be exhaustive or to limit the invention to the precise forms disclosed in the following detailed description. Rather, the embodiments are chosen and described so that others skilled in the art may utilize their teachings.

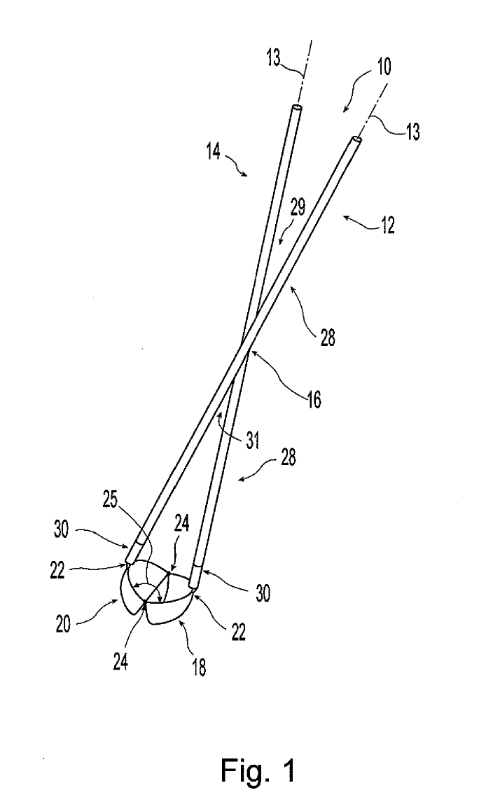

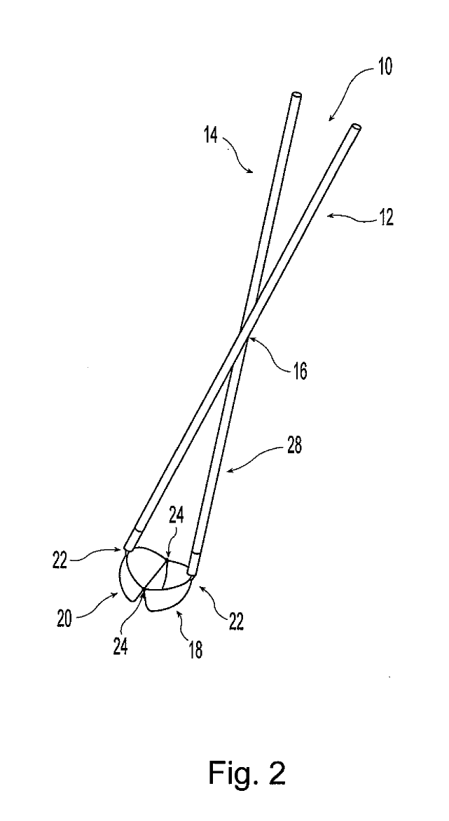

As shown in FIG. 1, a post hole digger 10 according to the present disclosure is shown. Post hole digger 10 includes a pair of handles 12, 14 that are pivotably connected at a hinge point 16. According to the exemplary embodiment, hinge point 16 extends through longitudinal axes 13 of handles 12, 14. Post hole digger 10 further includes a pair of spherical blades 18, 20 that are pivotably coupled to handles 12, 14 at pivot points 22 and pivotably coupled to each other at pivot points 24.

A user moves handles 12, 14 toward each other about pivot point 16 to open blades 18, 20. During this movement, an adjustable angle 25 defined between pivot points 22 and pivot point 24, as shown in FIG. 1, moves from an extreme of about 0 degrees when in the fully open position to an extreme of about 180 degrees when in the fully closed position. Angle 29, above pivot point 16, and angle 31, below pivot point 16, decrease as blades 18, 20 open and decrease as blades 18, 20 close.

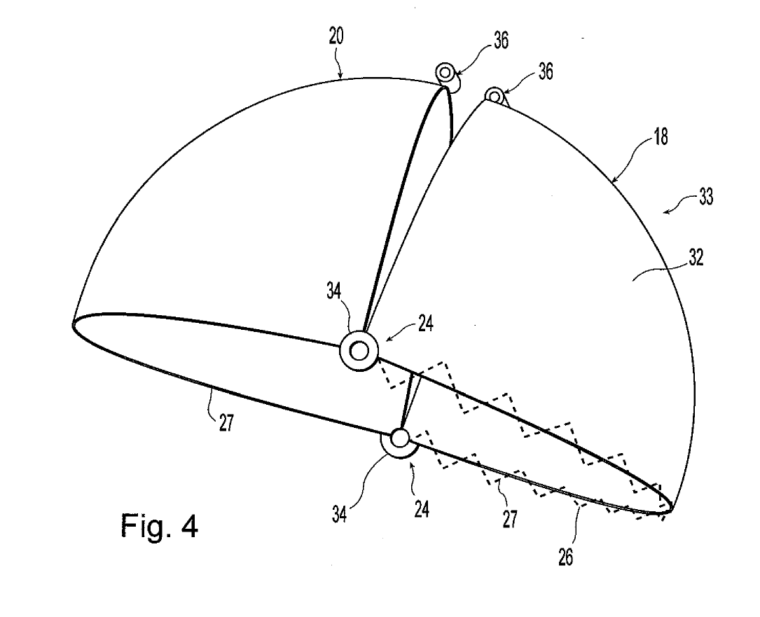

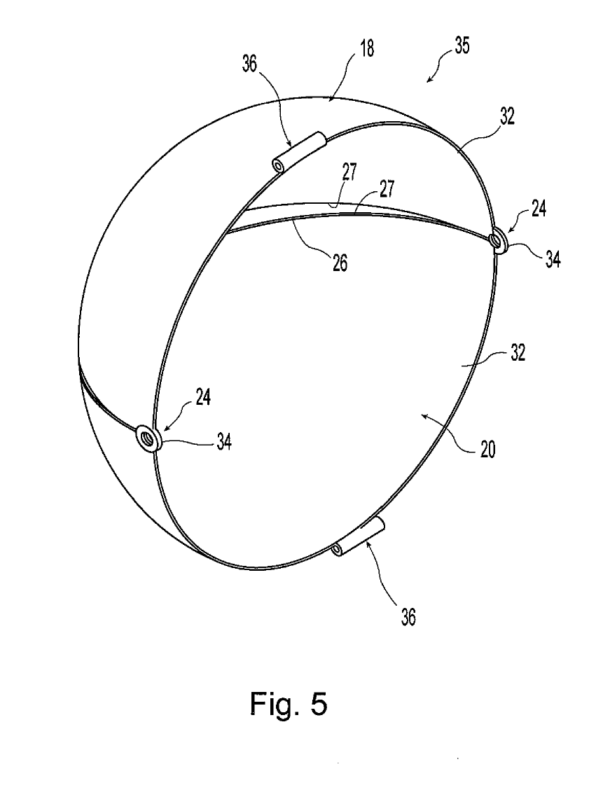

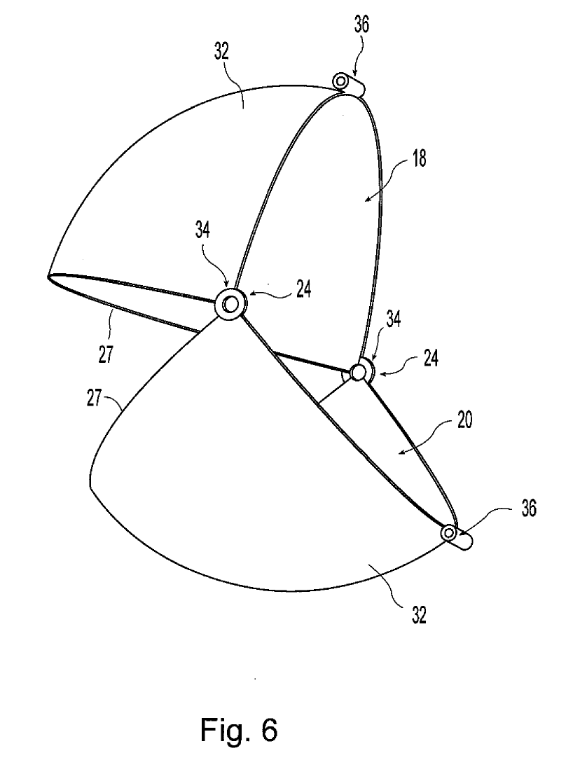

As shown in FIG. 4, blades 18, 20 include cutting edges 27 that define a circular opening 26 when in the open position with a circular cutting profile. While in this open position so that blades 18, 20 define an upper hemisphere 33, the user plunges post hole digger 10 downward into the earth to create a substantially circular hole in the earth. After plunging post hole digger 10 into the earth, the user spreads handles 12, 14 apart so that blades 18, 20 move to a closed position shown in FIG. 5 to define a lower hemisphere 35. While moving from the open position to the closed position, blades 18, 20 scoop up loose earth from the hole. Because blades 18, 20 are in the closed position, most of the earth that is scooped up by blades 18, 20 remains within blades 18, 20 during removal of post hole digger 10 from the hole.

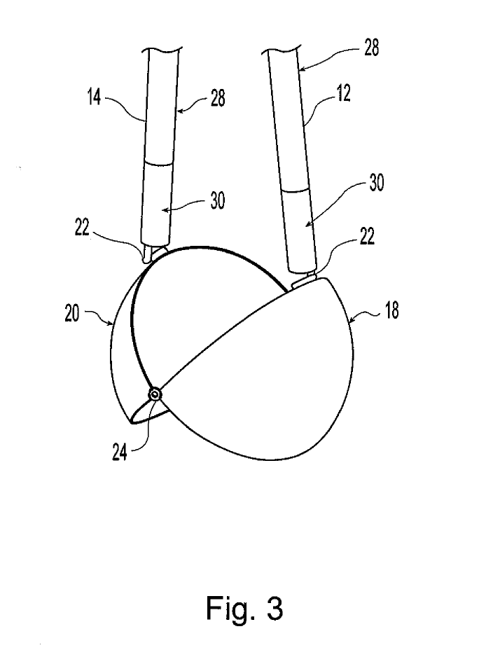

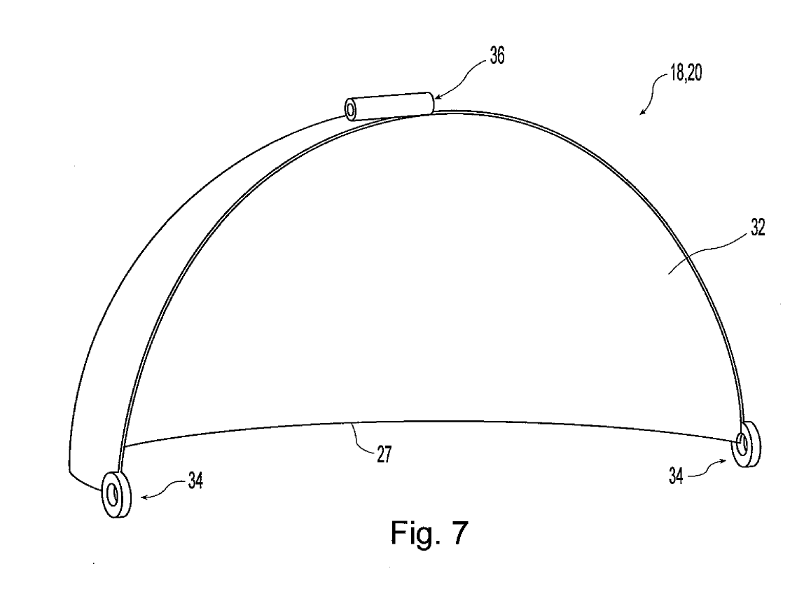

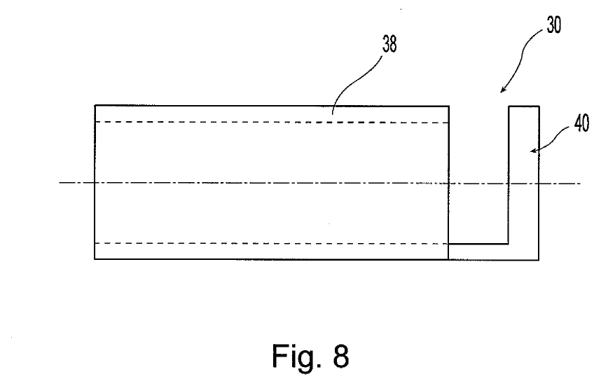

As shown in FIG. 1, handles 12, 14 include elongated rods 28 and a pair of hinge members 30 coupled to lower ends of rods 28. Hinge member 30 includes a cylindrical sleeve 38 that receives the lower end of rod 28 and a cylindrical pin 40. As shown in FIG. 7, each blade 18, 20 includes a spherical wall 32, a pair of eyelets 34, and a collar 36 that receives cylindrical pin 40. As shown in FIG. 3, hinge members 30 are coupled to rods 28 so that pins 40 extend in opposite directions and are inserted in collars 36 of the respective spherical blades 18, 20. Collars 36 are slightly off center on spherical wall 32 so that when blades 18, 20 are in the fully open position, collars 36 of the respective spherical blades 18, 20 do not interfere with each other. Fasteners (not shown) are provided that pivotably couple respective eyelets 34 of each respective spherical blade 18, 20 together.

Handles 12, 14 and blades 18, 20 cooperate to define a four bar linkage. The upper ends of handles 12, 14 provides a user input to the four bar linkage that allows a user to manipulate the position of blades 18, 20 to control the opening and closing of blades 18, 20. As discussed above, handles 12, 14 are pushed together to open blades 18, 20 and pulled apart to close blades 18, 20. During the movement from the open position to the closed position, blades 18, 20 rotate about 90 degrees from a position defining an upper hemisphere to a position defining a lower hemisphere. Preferably the edges of blades 18, 20 defining circular opening 26 are sharpened to facilitate insertion of blades 18, 20 into the earth. As shown in FIGS. 4 and 5, opening 26 is substantially circular when blades 18, 20 are in the open position (handles 12, 14 are together) and substantially closed when blades 18, 20 are in the closed position (handles 12, 14 are spread apart). Thus, the area of opening 26 is greater when blades 18, 20 are open than the area of opening 26 when blades 18, 20 are closed.

According to an exemplary embodiment of the present disclosure, the edges defining opening 26 are serrated creating offset teeth along these edges. The teeth are normally provided on both blades 18, 20, but are only shown on one blade 18 in phantom in FIG. 4 for illustrative purposes. Preferably these teeth mesh with the teeth on the opposite blade 18, 20 when in the closed position.

Preferably handle members are made of wood, fiberglass or other material suitable for post hole diggers. Blades 18, 20 are preferably made of heat treated steel. Furthermore, hinge members 30 of handles 12, 14 are also preferably made of heat treated steel to withstand the impact of repeated plunging of post hole digger 10 into the earth.

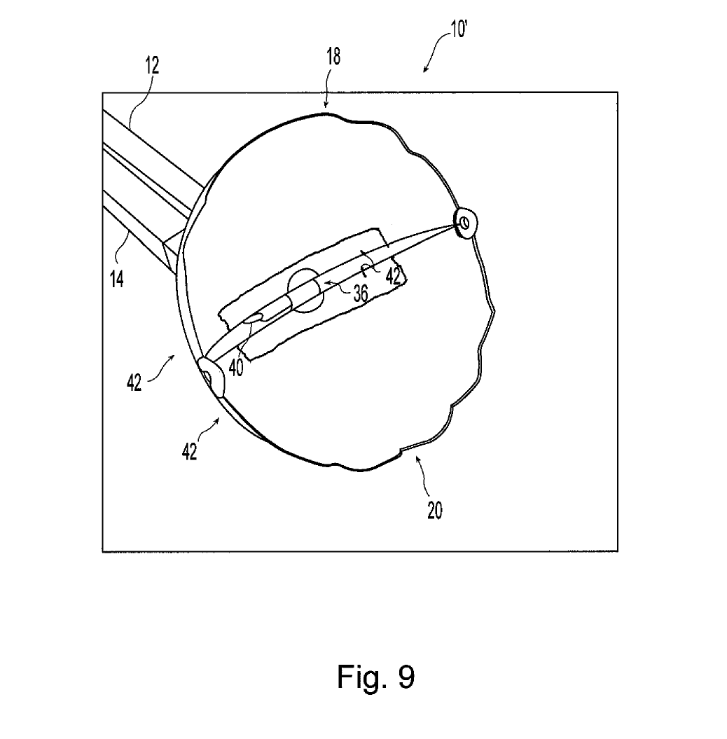

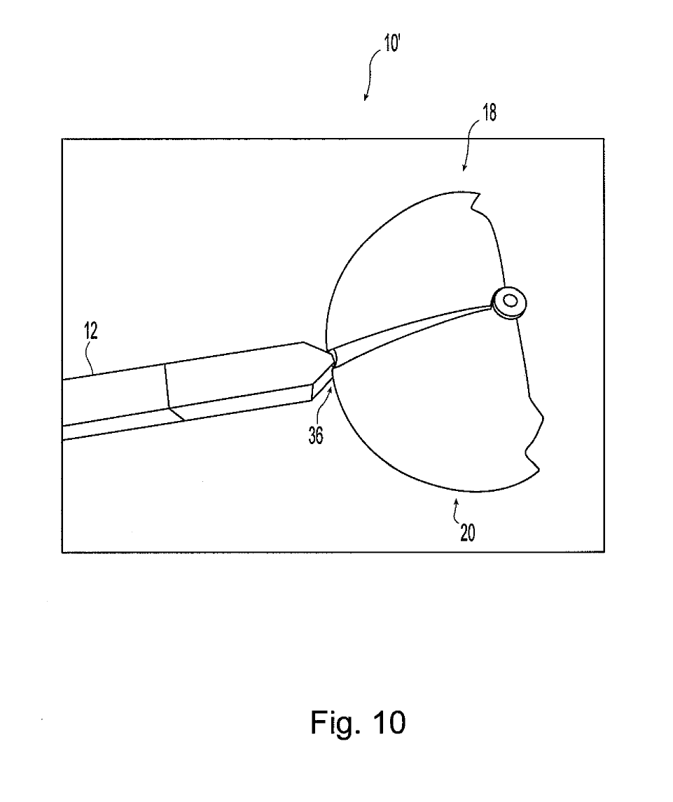

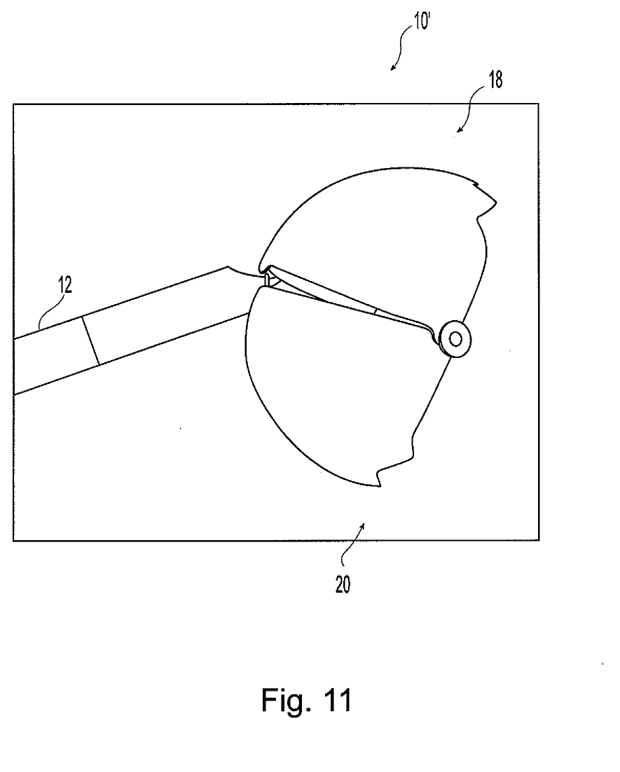

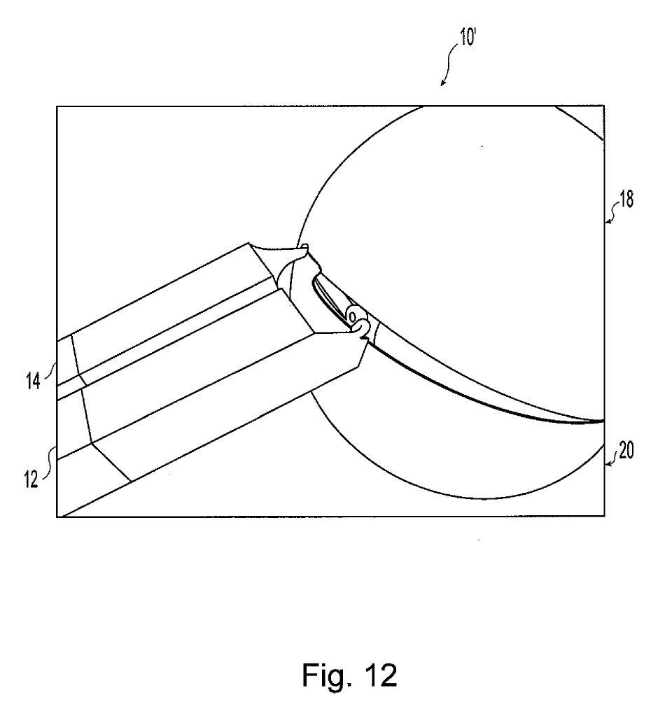

As shown in FIGS. 9-12, an alternative embodiment post hole digger 10′ is shown. Post hole digger 10′ is similar to post hole digger 10. As shown in FIG. 9, post hole digger 10′ includes a pair of reinforcement strips 42. Three sides of strips 42 are welded to respective blades 18, 20. Similarly, collars 36 are welded to reinforcement strips 42. As shown in FIGS. 9 and 10, collars 36 are positioned within or between blades 18, 20 when blades 18, 20 are in the closed position. When fully closed, cylindrical pins 40 of hinge members 30 are substantially aligned and permit blades 18, 20 to pivot in unison about pins 40. For example, in FIG. 10, the bottom of blades 18, 20 are substantially perpendicular to handles 12, 14. Whereas, in FIG. 11, the bottoms of blades 18, 20 are tilted relative to handles 12, 14.

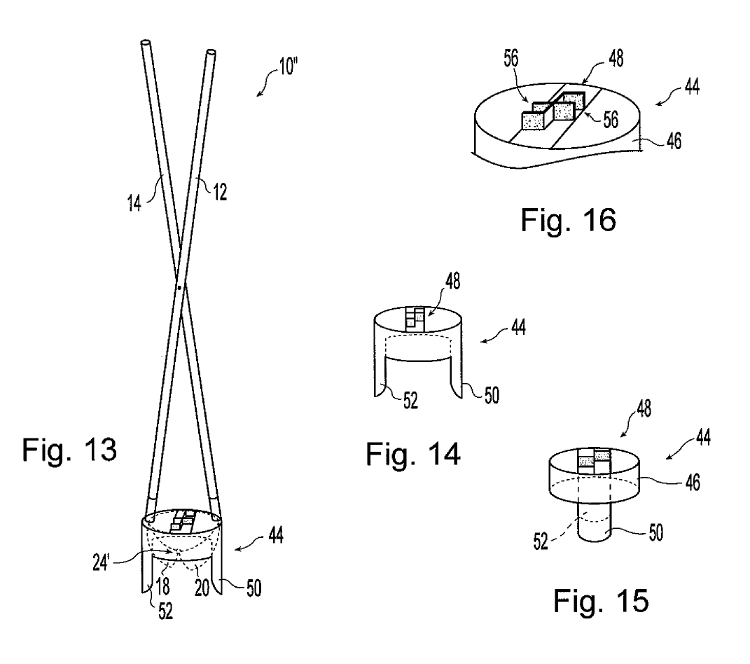

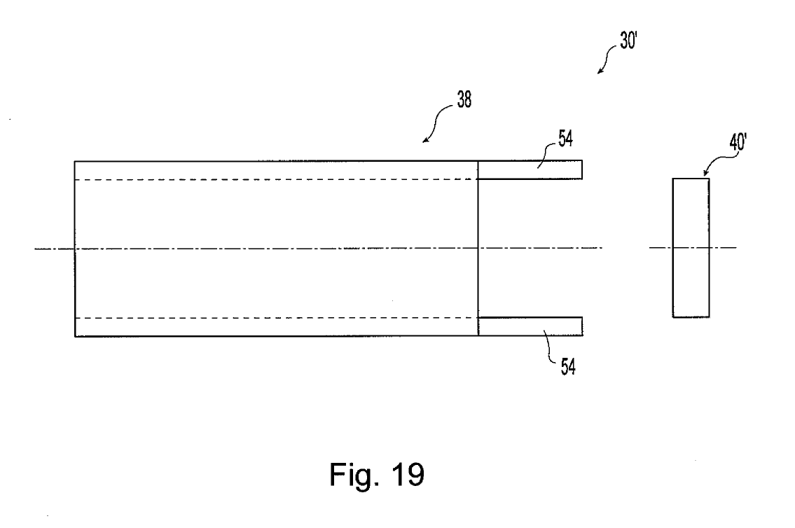

Another alternative embodiment post hole digger 10″ is shown in FIGS. 13-19. Post hole digger 10″ is similar to post hole diggers 10, 10′. As shown in FIG. 13, post hole digger 10″ includes an external shell 44 that includes a ring 46 coupled to blades 18, 20, a transverse member 48 extending across an upper portion of ring 46, and a pair of partially cylindrical blades 50, 52 extending down from ring 46.

Each spherical blade 18, 20 is coupled to each other and to ring 46 at pivot point 24′. Each pivot point 24′ includes a bolt, pin, rivet, or other similar component that extends through ring 46 and eyelets 34 of respective blade 18, 20. Blades 18, 20 rotate relative to external shell 44 during opening and closing of blades 18, 20 by handles 12, 14.

When post hole digger 10″ is plunged downward, blades 50, 52 dig into the ground and loosen the earth. A user than spreads handles 12, 14 to close spherical blades 18, 20. While closing, blades 18, 20 rotate downward about pivot point 24′ relative to external shell 44 and scope up the earth loosened by blades 50, 52 of external shell 44. After post hole digger 10″ is removed from the hole, the user closes handles 12, 14 so that spherical blades 18, 20 open and permit the scoped earth to fall out.

While opening to release the earth, blades 18, 20 rotate upward about pivot point 24′ relative to external shell 44. When in the opened position, lower ends of handles 12, 14 are positioned above transverse member 48 of external shell 44. When in this position during plunging of post hole digger 10″, transverse member 48 transfers downward force from handles 12, 14 to ring 46 and blades 50, 52.

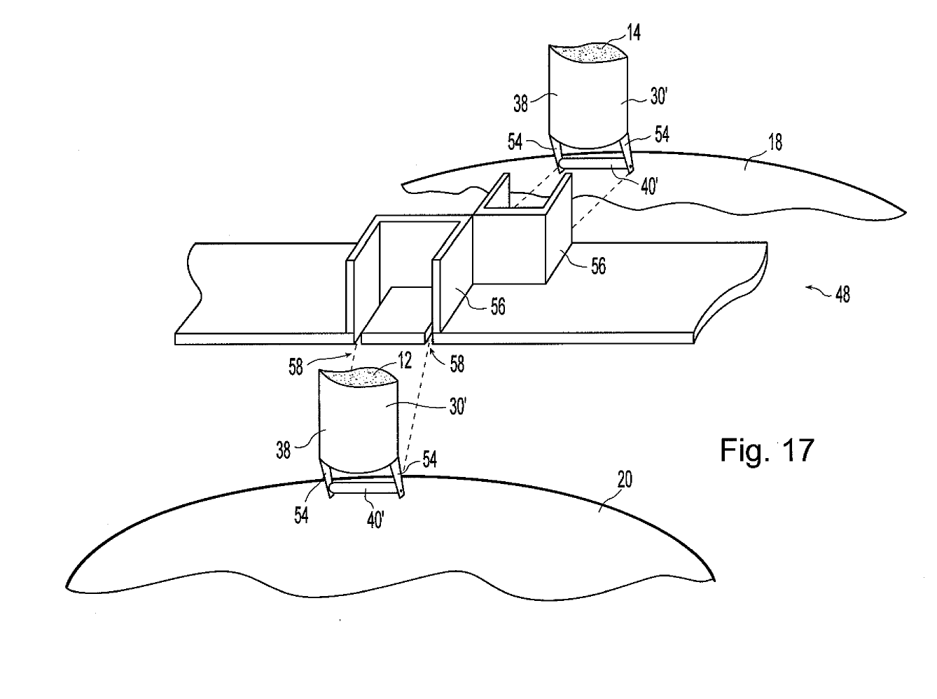

Transverse member 48 accommodates the transfer of force from the lower ends of handles 12, 14 and permit blades 18, 20 to rotate between the open and closed positions. As shown in FIG. 17, hinge member 30′ includes cylindrical sleeve 38′ and cylindrical pin 40′. A pair of extensions 54 extend down from cylindrical sleeve 38′ and couple to opposite ends of pin 40′. After assembly, pin 40′ is positioned within collars 36 so that blades 18, 20 can rotate relative to handles 12, 14.

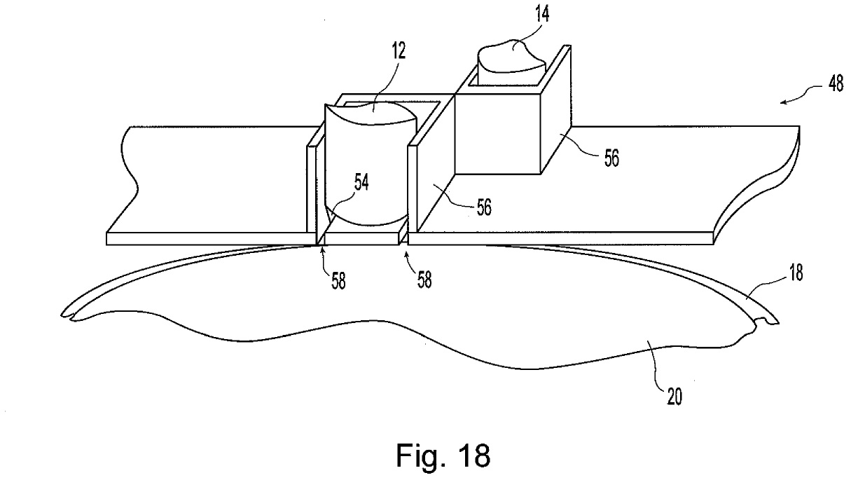

As shown in FIG. 18, transverse member 48 includes a pair of handle-receiving sockets 56 that receive the lower ends of handles 12, 14 when blades 18, 20 are in the open position. Sockets 56 include a pair of slits 58 that provide clearance for extensions 54. When blades 18, 20 are in the open position, pins 40′ and collars 36 (not shown in FIGS. 17 and 18) are positioned under transverse member 48 and the lower ends of handles 12, 14 are positioned above transverse member 48. Force from the lower ends of handles 12, 14 are then transferred to external shell 44 when post hole digger 10″ is plunged into the ground.

1-5. (canceled)

6. A post hole digger including
a first handle,
a second handled coupled to the first handle to provide movement therebetween,
a first blade coupled to the first handle to provide movement therebetween, and
a second blade coupled to the second handle to provide movement therebetween, the second blade being coupled to the first blade at a location to provide movement therebetween, the first and second blades being positioned below a substantial portion of the first and second handles, the first and second blades being moveable from a first position with a majority of the first and second blades being positioned above the location and a second position with the majority of the first and second blades being positioned below the location.

7. The post hole digger of claim 6, wherein the couplings of the first blade to the first handle and the second blade to the second handle are positioned above the location when the first and second blades are in the first position and at substantially the same vertical position as the location when the first and second blades are in the second position.

8. The post hole digger of claim 6, wherein the first and second blades include a cutting edge positioned to engage and loosen earth, the cutting edges of the first and second blades being positioned directly below the location when the first and second places are in the second position.

9. The post hole digger of claim 8, wherein the cutting edges are positioned at substantially the same vertical position as the location when the first and second blades are in the first position.

10. The post hole digger of claim 8, wherein the cutting edges define a substantially open, circular opening when in the first position that is closed when in the second position.

11. The post hole digger of claim 6, wherein the first and second handles are pivotably coupled together, the first blade is pivotably coupled to the first handle, the second blade is pivotably coupled to the second handle and the first blade, relative movement between the first and second handles rotating the first and second blades at least 20 degrees.

12. (canceled)

13. A post hole digger including
at least first and second handles pivotably coupled together at a pivot point, and
at least first and second blades positioned substantially below the first and second handles, the first blade being pivotably coupled to the first handle, the second blade being pivotably coupled to the second handle and the first blade, the first and second handles being movable relative to each other between first and second positions, the first and second handles cooperating to define a first angle therebetween above the pivot point when in the first position and a second angle therebetween above the pivot point when in the second position, the second angle being greater than the first angle, the first and second blades cooperating to define a lower opening, the lower opening having a first area when in the first position and a second area when in the second position that is less than the first area.

14. The post hole digger of claim 13, wherein first and second handles cooperate to define a third angle below the pivot point when in the first position and a fourth angle below the pivot point when in the second position, the fourth angle being greater than the third angle.

15. The post hole digger of claim 13, wherein the first and second handles have longitudinal axes and the pivot point extends through the longitudinal axes.

16. The post hole digger of claim 13, wherein the couplings of the first blade to the first handle and the second blade to the second handle are positioned directly below the pivot point when the first and second handles are in the first position.

17. The post hole digger of claim 16, wherein the coupling of the first blade to the second blade is positioned directly between the couplings of the first blade to the first handle and the second blade to the second handle.

18-25. (canceled)

26. A post hole digger including
a first handle in a vertical position,
a second handled coupled to the first handle to provide movement therebetween,
a first blade coupled to the first handle to provide movement therebetween, and
a second blade coupled to the second handle to provide movement therebetween, the first and second blades being coupled to provide movement therebetween from a first position to a second position, the first and second blades having cutting edges positioned in a substantially vertical position when in the first position to engage and loosen earth and portions in a substantially horizontal position when in the second position to support the loosened earth.

27. The post hole digger of claim 26, wherein the cutting edges cooperating to define a cutting profile when in the first position and the first and second blades are positioned within the cutting profile when in the second position.

28. The post hole digger of claim 26, wherein the cutting edges move from the first position outside of the loosened earth to the second position underneath the loosened earth.

29. The post hole digger of claim 26, wherein the cutting edges are positioned adjacent to each other when in the second position.

30. The post hole digger of claim 26, wherein the first and second blades are spherical.

31. The post hole digger of claim 26, wherein the first and second blades cooperate to define a continuous lower edge when in the first position defining an opening to receive earth.

32. The post hole digger of claim 31, wherein the continuous lower edge includes at least two cutting edges that engage and loosen earth and are positioned adjacent to each other when the first and second blades are in the second position.

33. The post hole digger of claim 32, wherein the two cutting edges rotate at least 45 degrees during movement from the first position to the second position.

34. (canceled)

35. (canceled)

36. The post hole digger of claim 13, wherein the first and second blades are spherical.
